(19) United States
(12) Patent Application Publication
(10) Pub. No.: US 2010/0119091 A1
(43) Pub. Date: May 13, 2010

(54) ACOUSTIC REPRODUCTION DEVICE

(75) Inventors: Suemei Fukuhara, Osaka (JP); Tsunenari Nishikawa, Osaka (JP); Shoji Tanaka, Hyogo (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/596,029

(22) PCT Filed: Mar. 7, 2008
(86) PCT No.: PCT/JP2008/000490

§ 371 Date: Oct. 15, 2009

(30) Foreign Application Priority Data
Apr. 16, 2007 (JP) 2007-107370

(51) Int. Cl. H04R 5/02

(52) U.S. Cl. 381/303

(57) ABSTRACT

An acoustic reproduction device includes first speaker units 12 and 15 that emit sound in an inward direction and second speaker units 13 and 16 that emit sound in a forward or outward direction. The first speaker units are arranged at positions symmetrical with respect to a listening center axis, and so are second speaker units. The device further includes first and second processing units that process center channel signals as signals for the first and the second speaker units, respectively. Front channel signals are superimposed on an output signal of the second processing unit. The first processing unit includes a HPF 33 and a first high-shelf block 34 for boosting a high-range component. The second processing unit includes an LPF 38, a low-shelf block 36 for attenuating a low-range component, and a second high-shelf block 37 for attenuating a high-range component. Center channel reproduction sounds arriving from the first speaker unit and the second speaker unit that are closer to a listening position are destructive to each other in the mid-range owing to a phase difference therebetween. It is possible to expand a listening position range where the center sound image localization can be achieved, and to integrate a center speaker into a front speaker system.

### TECHNICAL FIELD

The present invention relates to an acoustic reproduction device for use in movie multichannel sound reproduction equipment such as stereophonic reproduction equipment or a so-called home theater system.

### BACKGROUND ART

Generally, in order to achieve excellent sound image localization in stereophonic reproduction, it is necessary to listen to sounds at the midmost position between right and left speakers, that is, at a position on a symmetry axis with respect to which the left and right pairs of speakers are symmetric. In other words, if the listening position is deviated from the midmost, closer to one of the speakers, the reproduced sound such as a singing voice or another sound that should be heard from the vicinity of the midpoint between the right and left speakers is heard from the speaker closer to the listening position, whereby sound images are biased toward the speaker closer to the listening position. This is well known.

Further, as a method for reproducing movie multichannel in a so-called home theater system, a method is available in which a center channel signal is reproduced by right and left front speakers without installing an independent center speaker. This is, in other words, in this method the center channel signals are divided equally between right and left front speakers and are superimposed on front channel signals.

This method has an advantage that there is no need to install an independent center speaker. On the other hand, the listening range where excellent sound image localization of center channel audio signals can be achieved is limited to the midmost area between the right and left front speakers, as is the case with the stereophonic reproduction.

In the case of the home theater reproduction in particular, it is desired that sound images of center channel audio signals be localized in the vicinity of the center of a screen, so that sounds and video images match each other. In the case where center channel signals are reproduced by right and left speakers as described above, if the listening position is deviated from the midmost area, sound images of voice such as speech on the center channel are localized at positions extremely deviated from the screen center, which causes a listener to feel a sense of discomfort. Thus, natural reproduction of movies cannot be performed.

This is described below with reference to FIG. 13. FIG. 13 is an explanatory view illustrating the effect of a conventional speaker device, in which a left-side speaker system 50 and a right-side speaker system 51 are arranged at positions symmetrical with respect to a listening center axis X1-X2, and a display 52 is installed at the center. The drawing shows a case where a listening position P is deviated leftward.

Sound emitted by a speaker unit 53 of the left-side speaker system 50 and sound emitted by a speaker unit 54 of the right-side speaker system 51 form a synthetic sound pressure vector Vt at the listening position P. The right-side speaker unit 54 is farther from the listening position P than the left-side speaker unit 53 is, and the direction thereof is oblique. Therefore, a sound pressure vector V2 of the right-side speaker unit 54 at the listening position P is made significantly smaller than a sound pressure vector V1 of the left-side speaker unit 53 by the attenuation due to distance and the directivity.

Therefore, in the synthetic sound pressure vector Vt, the sound pressure vector V1 of the left-side speaker unit 53 is dominant, whereby a sound image localization position S is dose to the left-side speaker system 50, lying off the display 52.

Still further, the precedence effect also is caused, as is well known. The precedence effect is the following auditory physiological phenomenon: even if two sounds arriving at the same location have the same intensities, the sound arriving slightly earlier in time is perceived to be more intense. The sound from the left-side speaker unit 53 arrives at the listening position P earlier than the sound from the right-side speaker unit 54. As a result, the precedence effect is caused, and the sound from the left-side speaker unit 53 is perceived to be more intense, whereby the actual sound image localization position S tends to be deviated further leftward, even as compared with FIG. 13.

As described above, the listening position range is limited to the midmost in order to achieve the sound image localization at the center (hereinafter referred to as “center sound image localization”). Therefore, with the method in which no independent center speaker is installed, it is impossible for a plurality of persons to be involved at once in natural appreciation of movies. Likewise, in the stereo music reproduction also, it is impossible for a plurality of persons to be involved at once in music appreciation with excellent sound image localization.

It appears that in the case of the home theater movie reproduction, the above-described problem is solved by installing a center speaker. In such a case, however, the center speaker has to be installed above or below the display, which causes upper or lower sound image localization positions of center channel audio signals to lie off the screen. Therefore, in the home theater movie reproduction employing a large display or screen in particular, the mismatch between sounds and video images becomes remarkable, which makes it impossible to allow natural appreciation of movies.

To solve the problem that the listening position range is limited to the midmost between the right and left speaker systems in order to achieve the center sound image localization, for example, a speaker device as shown in FIG. 14 is proposed in the Patent Document 1. In FIG. 14, in a left-side speaker system 55, two speaker units 56a and 56b are arranged horizontally in a cabinet 55a, while in a right-side speaker system 57, two speaker units 58a and 58b are arranged horizontally in a cabinet 57a.

The speaker units 56a and 56b are driven with frequencies in a range of 100 Hz to 2 kHz, for example, with a predetermined phase difference being provided from each other, and so are the speaker unit 58a and 58b. By so doing, the speaker systems 55 and 57 form dipole-like sound sources. This dipole-like sound source has frequency characteristics in that emission power attenuates in the mid-frequency range and below. Therefore, the frequency characteristic is corrected by a large-scale boosting on the low frequency side up to 200 Hz.

With this configuration, for a listener PL on the left side shown in FIG. 14, for example, the sound pressure from the speaker system 55 immediately in front of the listener is minimized by the dipole emission characteristic of the speaker units 56a and 56b. On the other hand, since the sound pressure from the right-side speaker system 57 is at a considerable level, a sound image localization position is deviated toward the right-side speaker system 57 for the listener PL on the left side, whereby the center sound image localization can be achieved.

Patent Document 1: JP 4 (1992)-23399 U

### DISCLOSURE OF INVENTION

### Problem to be Solved by the Invention

The conventional speaker device disclosed by the Patent Document 1 needs large-scale boosting on the low frequency side so as to correct the emission power attenuation characteristic of the dipole-like sound source in the mid-range and below. Therefore, extremely large electric power is supplied to the speaker units 56a, 56b, 58a, and 58b, thereby damaging the speakers or distorting sounds. Thus, the foregoing speaker device has a problem that a high sound pressure level cannot be obtained.

Further, since the directivity of the speaker units 56a, 56b, 58a, and 58b becomes acute in the treble range, for example, the sound pressure level in the treble range reaching the listener PL on the left side from the right-side speaker system 55 falls significantly. As a result, the effect of improving the sound image localization position falls drastically in the treble range, and the effect of improving the sound image localization position cannot be achieved sufficiently.

Still further, sounds in a low frequency band emitted from a dipole-like sound source give a sense of significant discomfort. This is because a low frequency sound has an extremely long wavelength, and hence the sound emitted from each speaker unit reaches right and left ears of a human, with a phase difference being maintained completely. In other words, for example, for a listener PL on the left side, the sounds from the speaker unit 56b predominantly reach the left ear, while the sounds from the speaker unit 56a predominantly reach the right ear. Therefore, the right and left ears constantly hear sounds with phases reverse to each other, respectively, which causes the listener to feel a sense of significant discomfort.

An object of the present invention is to provide an acoustic reproduction device that has an excellent effect in expanding a listening position range where the center sound image localization can be achieved with respect to voices such as singing and speech; and that is configured so that a center speaker for multichannel sound reproduction can be provided integrally with left-side and right-side front speaker systems.

### Means to Solve the Problem

An acoustic reproduction device of the present invention includes: a pair of speaker systems, each speaker system having a first speaker unit and a second speaker unit; a signal processing unit that performs a predetermined processing operation with respect to an input signal; and an amplifier that amplifies an output signal from the signal processing unit, and applies the signal to the speaker systems, wherein when the pair of speaker systems are arranged symmetrically with respect to a listening center axis, the first speaker units are arranged symmetrically with respect to the listening center axis, and the second speaker units are arranged symmetrically with respect to the listening center axis.

To solve the above-described problems, the first and second speaker units are arranged so that the first speaker unit emits a sound in an inward direction, and the second speaker unit emits a sound in a front direction of the speaker system or in an outward direction as compared with the direction of the first speaker unit, where the inward direction is defined as a direction toward the listening center axis from each speaker system. The signal processing unit is configured so as to include a first processing part that processes a center channel signal, of multichannel signals supplied as input signals, and outputs the processed signal as a signal for the first speaker unit, and a second processing part that processes the center channel signal and outputs the processed signal as a signal for the second speaker unit, and is configured to superimpose respective front channel signals, of the multichannel signals, onto the output signal of the second processing part, and supply the signals in the superimposed state to the second speaker units, respectively.

The first processing part includes a HPF (high-pass filter) block that performs a processing operation for attenuating a low-range component of the center channel signal; and a first high-shelf block that performs a processing operation for obtaining step-like characteristics for boosting a high-range component. The second processing part includes a LPF (low-pass filter) block that performs a processing operation for attenuating a high-range component of the center channel signal; a low-shelf block that performs a processing operation for obtaining step-like characteristics for attenuating a part of a low-range signal component, of signal components in a band below the high-range component attenuated by the low-pass filter block; and a second high-shelf block that performs a processing operation for obtaining a step-like characteristics for attenuating a part of a high-range signal component. The acoustic reproduction device is configured so that at a listening position in a front direction of one of the speaker systems, a reproduced sound of the center channel signal arriving from the first speaker unit of the one of the speaker systems that is closer to the listening position, and a reproduced sound of the center channel signal arriving from the second speaker unit of the same speaker system, are destructive to each other in the mid-range owing to a phase difference therebetween.

### EFFECT OF THE INVENTION

With the configuration as described above, it is possible to realize a simple acoustic reproduction device for multichannel reproduction that does not require that an independent center speaker should be installed therein, and moreover, to obtain an excellent effect in expanding a listening position range in which the center sound image localization can be achieved with respect to center channel audio signals. Further, it is possible to obtain a smooth total frequency characteristic in a predetermined frequency band even in the case where a sufficient distance in the horizontal direction cannot be ensured between the first speaker unit and the second speaker unit.

### BRIEF DESCRIPTION OF DRAWINGS

FIG. 1 illustrates a configuration of a speaker device in a basic configuration of the present invention.

FIG. 2 is a perspective view of the speaker device in the basic configuration.

FIG. 3 is a network circuit diagram of the speaker device in the basic configuration.

FIG. 4 is a diagram showing respective frequency characteristics of speaker units in the speaker device in the basic configuration.

FIG. 5 is a diagram showing frequency characteristics of the speaker device in the basic configuration.

FIG. 6 is an explanatory view showing an operation in the mid-range of the speaker device in the basic configuration.

FIG. 7 is an explanatory view showing an operation in the treble range of the speaker device in the basic configuration.

FIG. 8 is a block diagram of an acoustic reproduction device in another configuration in the case where the speaker device in the foregoing basic configuration is applied for multichannel reproduction.

FIG. 9 is a perspective view illustrating an exemplary configuration of a speaker device in which an Embodiment of the present invention is applied.

FIG. 10 is a block diagram illustrating a configuration of a signal processing unit of the acoustic reproduction device according to an Embodiment of the present invention.

FIG. 11 is a diagram showing frequency characteristics of the acoustic reproduction device according to the Embodiment.

FIG. 12 illustrates a configuration in the case where speaker units are arranged in another manner in the acoustic reproduction device.

FIG. 13 is an explanatory view illustrating an operation of a conventional speaker device.

FIG. 14 illustrates a configuration of a conventional speaker device.

### DESCRIPTION OF REFERENCE NUMERALS

| | |
|---|---|
| 1, 11, 40, 50, 55 | left-side speaker system |
| 1a, 4a, 42, 43, 55a, 57a | cabinet |
| 2, 5, 12, 15 | first speaker unit |
| 3, 6, 13, 16 | second speaker unit |
| 4, 14, 41, 51, 57 | right-side speaker system |
| 7, 52 | display |
| 17 | HPF |
| 18 | inverter |
| 19 | center channel amplifier (C) |
| 20 | LPF |
| 21 | front channel amplifier (R + C) |
| 22 | front channel amplifier (L + C) |
| 23 | speaker system |
| 23a | cabinet |
| 24 | first speaker unit |
| 25 | second speaker unit |
| 30 | signal processing unit |
| 31 | first processing part |
| 32 | second processing part |
| 33 | HPF block |
| 34 | first high-shelf block |
| 35 | phase reversing block |
| 36 | low-shelf block |
| 37 | second high-shelf block |
| 38 | LPF block |
| 39 | level adjusting block |
| 53, 54, 56a, 56b, 58a, 58b | speaker unit |

### DESCRIPTION OF THE INVENTION

The acoustic reproduction device of the present invention may have the following various modifications based on the above-described configuration.

More specifically, the mid-range preferably is set to a frequency range including 1.5 kHz.

Further, it is preferable that the mid-range is set to a frequency range including a part or an entirety of the second formant frequency and the third formant frequency of human voice. This makes it possible to achieve an excellent effect of expanding the listening position range in which the center sound image localization can be achieved with respect to voice such as singing and speech in particular.

Further, the configuration may be such that the first speaker unit is arranged on an inner side with respect to the second speaker unit as viewed from the listening center axis, and in the mid-range, a phase of an emitted sound of the first speaker unit is delayed as compared with a phase of an emitted sound of the second speaker unit. This makes it possible to achieve an excellent effect of expanding the listening position range in which the center sound image localization can be achieved, and to downsize the speaker system in the front-back direction.

Alternatively, the configuration may be such that the first speaker unit is arranged on an outer side with respect to the second speaker unit as viewed from the listening center axis, and in the mid-range, a phase of an emitted sound of the first speaker unit is advanced as compared with a phase of an emitted sound of the second speaker unit. This makes it possible to achieve an excellent effect of expanding the listening position range in which the center sound image localization can be achieved, and to dispose the speaker systems more backward, thereby increasing the degree of freedom in the arrangement.

Still further, the first speaker unit and the second speaker unit may be arranged in a vertical relationship, whereby the speaker systems can be downsized in the width direction.

The following describes embodiments of the present invention in detail, while referring to the drawings.

Basic Concept

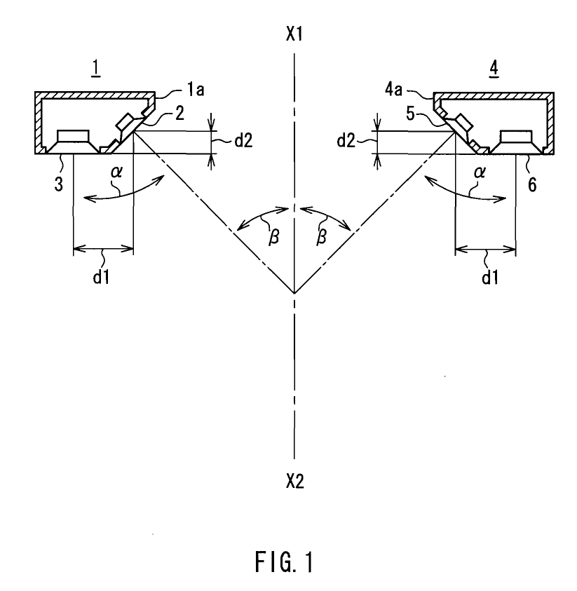

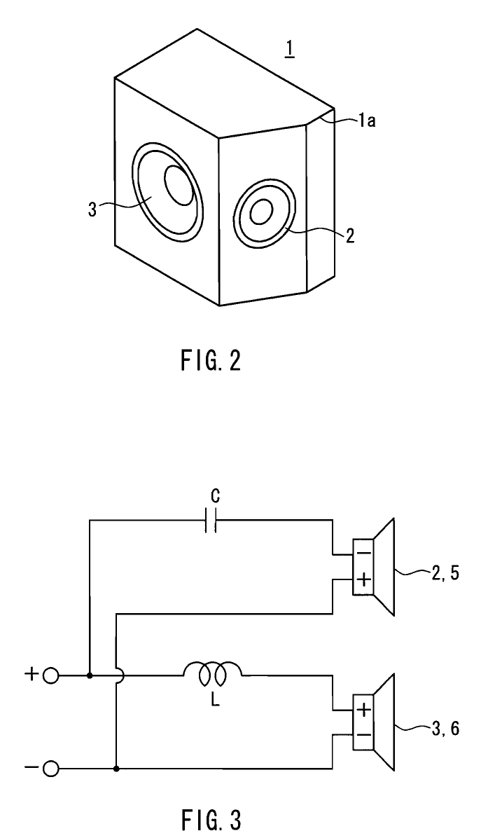

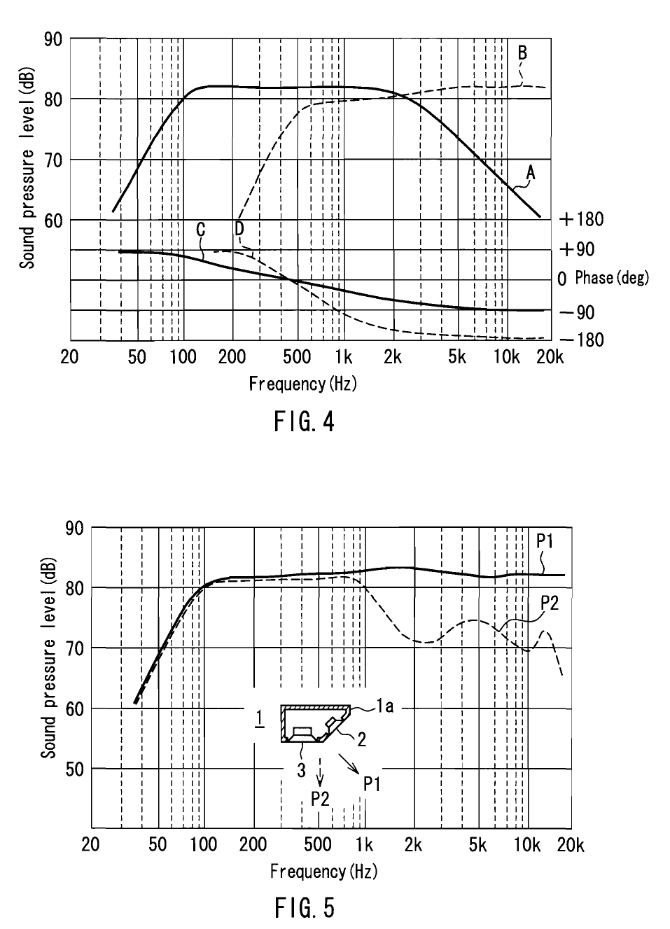

First of all, a basic concept of a speaker device included in an acoustic reproduction device according to an Embodiment of the present invention is described below, with reference to FIGS. 1 to 4. FIG. 1 shows a configuration of a speaker device according to an Embodiment of the present invention. FIG. 2 is a perspective view of the forgoing speaker device. FIG. 3 is a network circuit diagram of the foregoing speaker device. FIG. 4 is a frequency characteristic diagram of each speaker unit of the foregoing speaker device.

In FIG. 1, the left-side speaker system 1 and the right-side speaker system 4 are placed on both sides of a listening center axis X1-X2, at substantially the same distances from the listening center axis X1-X2. In a cabinet 1a of the left-side speaker system 1, there are installed a first speaker unit 2 and a second speaker unit 3. In a cabinet 4a of the right-side speaker system 4, there are installed a first speaker unit 5 and a second speaker unit 6. The arrangement of the speaker units 2, 3, 5, and 6 is symmetrical with respect to the listening center axis X1-X2.

Each of the first speaker units 2 and 5 is, for example, a 6.5-cm-diameter full-range unit, and is sealed on the back so that its diaphragm is not vibrated by the air pressure of a bass sound in the cabinet. Each of the second speaker units 3 and 6 is a 8-cm-diameter bass-range unit, for example.

Defining each direction from each of the speaker systems 1 and 4 toward the listening center axis X1-X2 to be an inward direction, the first speaker units 2 and 5 are positioned on inner sides with respect to the second speaker units 3 and 6, respectively, and are arranged so as to emit sounds in the inward direction. The second speaker units 3 and 6 are arranged so as to emit sounds in a front direction, and hence, they emit sounds in directions outward with respect to the directions of the first speaker units 2 and 5, respectively.

Angles β of the sound emission direction of each of the first speaker units 2 and 5 with respect to the listening center axis X1-X2 are approximately 45°. Therefore, each angle α between the sound emission directions of the second speaker units 3 and 6 and the sound emission directions of the first speaker units 2 and 5, respectively, is approximately 45°. A distance d1 in the horizontal direction between the first speaker units 2 and 5 and the second speaker units 3 and 6, respectively, is approximately 9 cm, and a distance d2 in the depth direction therebetween is approximately 4 cm. The first speaker units 2 and 5 and the second speaker units 3 and 6 are arranged horizontally as shown in the perspective view of FIG. 2.

As shown in FIG. 3 schematically, signals to drive this speaker device are supplied via a 6-dB/oct-type network circuit composed of a low-range cut-off capacitor C and a high-range cut-off coil L. By so doing, signals whose low range is attenuated are fed to the first speaker units 2 and 5, while signals whose high range is attenuated are fed to the second speaker units 3 and 6. Besides, the first speaker units 2 and 5 and the second speaker units 3 and 6 are connected to a network circuit, with polarities reverse to each other, respectively.

Frequency characteristics of the speaker units 2, 3, 5, and 6 at the same measurement distances on the axes are as shown in FIG. 4. Sound pressure frequency characteristics of the first speaker units 2 and 5 are indicated with a broken line B, and a phase frequency characteristic thereof is indicated with a broken line D. A sound pressure frequency characteristic of the second speaker units 3 and 6 is indicated with a solid line A, and a phase frequency characteristic thereof is indicated with a solid line C.

The frequency characteristics in FIG. 4 show a synergistic effect of characteristics of the speaker units 2, 3, 5, and 6, and division characteristic of the network circuit shown in FIG. 3. As a result, the first speaker units 2 and 5 have a reproduction frequency band of not lower than about 500 Hz (−6 dB), as indicated by the broken line B. The second speaker units 3 and 6 have a reproduction frequency band ranging from a bass range to about 4 kHz (−6 dB), as indicated by the solid line A. Therefore, mid-range sounds of about 500 Hz to 4 kHz are reproduced by both of the first speaker units 2 and 5 and the second speaker units 3 and 6.

It should be noted that as clear from the characteristics indicated by A and B in FIG. 4, in the mid-range, the sound pressure level of the first speaker units 2 and 5 is set slightly lower than that of the second speaker units 3 and 6. This is intended to adjust the effect of the center sound image localization, as described below.

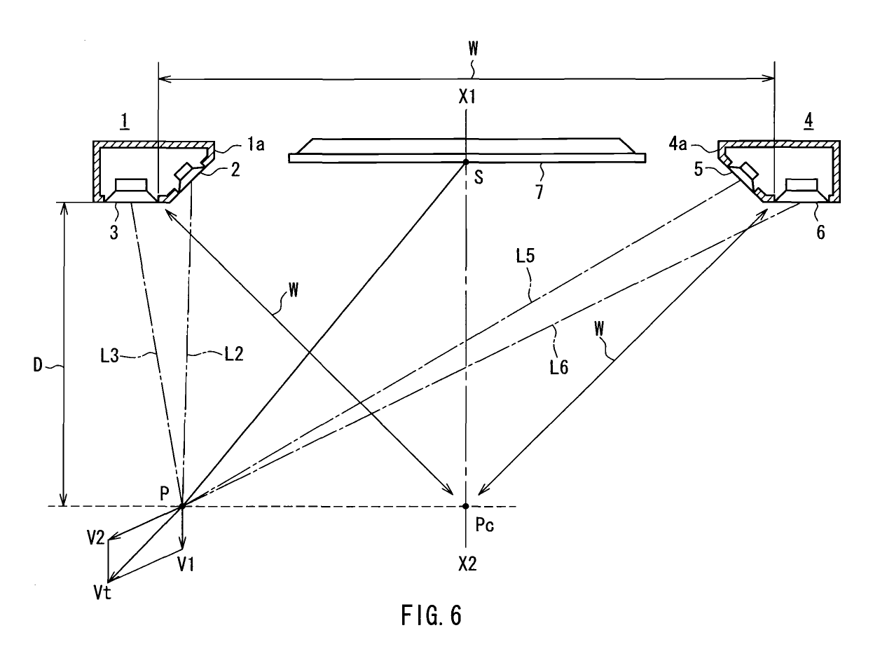

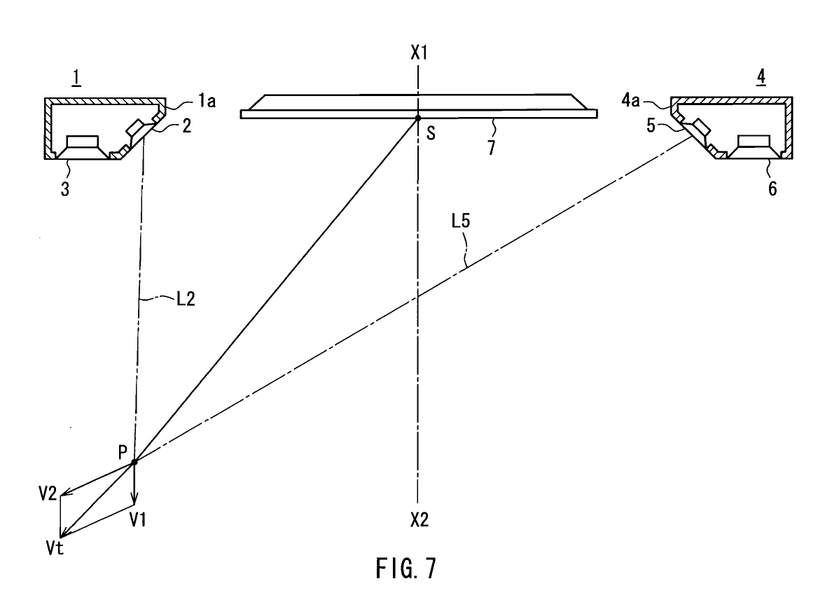

The following further describes the operation and effect of the speaker device configured as described above, while referring to FIGS. 5 to 7. FIG. 5 is a frequency characteristic diagram of the speaker device configured as described above. FIG. 6 is an explanatory view showing the operation of the foregoing speaker device in the mid-range, and FIG. 7 is an explanatory view showing the operation of the foregoing speaker device in the treble range.

In FIG. 5, a solid line P1 represents a sound pressure frequency characteristic of the speaker system 1 (or 4) in the front direction of the first speaker unit 2 (or 5), as shown in a reference drawing in FIG. 5. A broken line P2 represents sound pressure frequency characteristic of the speaker system 1 (4) in the front direction of the second speaker unit 3 (6), in other words, in the front direction of the speaker system 1 (4). The following characteristics are obtained: a high sound pressure level is obtained in the front direction of the first speaker unit 2 (P1), while the sound pressure level significantly attenuates in the mid-range band and above in the front direction of the speaker system 1 (P2).

The principle and effect for obtaining such characteristics are described in detail. As represented by the solid line C in FIG. 4, with regard to the second speaker units 3 and 6, an emitted sound in a mid-range of several hundreds Hz, which is a middle range of a reproduction band, has a phase of about 0°. This phase is delayed by about 90° toward the treble range by a 6-dB/oct-type low-pass filter (high-cut) network circuit (FIG. 3). It should be noted that the reason why the phase advances in the bass range is that attenuation occurs in the low frequency range.

With regard to the first speaker units 2 and 5, since they are connected in reverse phase as shown in FIG. 3, a phase frequency characteristic thereof delays by 180° in the treble range as represented by a dotted line D in FIG. 4. Assuming that the first speaker units 2 and 5 are connected in normal phase, as is the case with the second speaker units 3 and 6, the phase thereof would be 0° in the treble range. Then, the phase advances by about 90° toward the bass range side by the 6-dB/oct-type high-pass filter (low-cut) network circuit, and the phase further advances due to the attenuation in the bass range of the speaker units 2 and 5 themselves. In other words, in a range from the mid-range to the treble range, the phase (the dotted line D) of the emitted sound of the first speaker units 2 and 5 has a delay of about 90° as compared with the phase of the emitted sound of the second speaker units 3 and 6.

As a result, the sound pressure frequency characteristic of the speaker system 1 (4) in the vicinity of the front direction of the first speaker unit 2 (5) is such a characteristic, obtained by adding respective sound pressures of the first speaker unit 2 (5) and the second speaker unit 3 (6), as represented by the solid line P1 shown in FIG. 5. On the other hand, the sound pressure frequency characteristic of the speaker system 1 (4) in the vicinity of the front direction of the second speaker unit 3 (6) is such a characteristic having level attenuation in a range from the mid-range to the treble range as represented by the dotted line P2 in FIG. 5.

The principle and effect thereof are described with reference to FIG. 6. In FIG. 6, a display 7 is installed at the midpoint between the left-side speaker system 1 and the right-side speaker system 4, and a center position of the display 7 is denoted as S. An ideal center listening position Pc lies on the listening center axis X1-X2. Assume that an actual listening position P lies approximately in the front direction of the speaker system 1 closer thereto. Each of the speaker systems 1 and 4 is similar to that shown in FIG. 1.

The position relationship between the center listening position Pc and the speaker systems 1 and 4 is in a standard arrangement in which they are positioned in the vicinities of vertexes of an approximate regular triangle, respectively. Therefore, a depth-direction distance D from the speaker systems 1 and 4 to the listening positions Pc and P is in a positional relationship satisfying D=0.87 W. “W” represents a distance between the speaker systems 1 and 4. This standard arrangement is recommended not only for the conventional 2-channel stereo reproduction, but also for multichannel speaker systems in the ITU-R Recommendations.

Since the first speaker units 2 and 5 are arranged at inner positions as compared with the second speaker units 3 and 6, respectively, as shown in FIG. 6, a distance L5 from the first speaker unit 5 of the speaker system 4, which is farther from the listening position P, to the listening position P is shorter than a distance L6 from the second speaker unit 6 to the listening position P. For example, in the above-described standard speaker system arrangement relationship and the configuration dimensions of the speaker device of the present embodiment, the distance L5 is about 4 cm shorter than the distance L6.

Since the phase of the emitted sound of the first speaker unit 5 delays by about 90° in the mid-range originally (immediately after the emission from the speaker unit) as compared with the phase of the emitted sound of the second speaker unit 6, the phase difference at the listening point P between the respective arriving sounds from the foregoing units is caused to decrease due to L5 being shorter than L6. As a result, the phase difference between the arriving sound from the first speaker unit 5 and the arriving sound from the second speaker unit 6 approaches 0°, whereby both the emitted sounds are constructive each other.

On the other hand, in the speaker system 1 closer to the listening position P, the distance L2 from the first speaker unit 2 to the listening position P is greater than the distance L3 from the second speaker unit 3 to the listening position P. For example, in the above-described standard speaker system arrangement relationship and the dimensions of the speaker unit arrangement relationship of the speaker device of the present embodiment, the distance L2 is about 4 cm longer than the distance L3.

Since the phase of the emitted sound of the first speaker unit 2 delays by about 90° in the mid-range originally as compared with the phase of the emitted sound of the second speaker unit 3, the phase difference at the listening point P between the respective arriving sounds from the foregoing units is caused to increase due to L3 being shorter than L2. As a result, the phase difference between the arriving sound from the first speaker unit 5 and the arriving sound from the second speaker unit 6 approaches 180°, whereby both the emitted sounds are destructive to each other.

The above effect is maximized at the frequency with which a sound wave has a phase rotation of 90° due to the distance difference between L5 and L6 or the distance difference between L2 and L3, that is, at the frequency with which the distance difference becomes equal to ¼ the wavelength of the sound. In the above-described configuration, the distance difference between L5 and L6 and the distance difference between L2 and L3 are 4 cm each. Therefore, the above-described effect is maximized in the vicinity of 2 kHz at which 4 cm is equivalent to ¼ wavelength. As the frequency decreases from the vicinity of 2 kHz, this effect gradually decreases. This applies to the speaker system 1 closer to the listening position P similarly.

As the frequency increases from the vicinity of 2 kHz, the foregoing effect gradually declines. For example, in the vicinity of 4 kHz at which the distance difference of 4 cm is equivalent to ½ wavelength, the sound wave has a phase advance of 180° due to the distance difference, whereby the phase of the arriving sound from the first speaker unit 5 to the listening position P advances by 90° with respect to the phase of the arriving sound from the second speaker unit 6 to the listening position P. In other words, in the vicinity of 4 kHz, the arriving sound from the first speaker unit 5 and the arriving sound from the second speaker unit 6 are not constructive to each other, and hence, the above-described effect is minimized.

This also occurs with the speaker system 1 closer to the listening position P. That is, in the vicinity of 4 kHz, a sound wave has a phase delay of 180° due to a distance difference, and this results in that the phase of the arriving sound from the first speaker unit 2 to the listening position P delays by 270° as compared with the phase of the arriving sound from the second speaker unit 3 to the listening position P. In other words, in the vicinity of 4 kHz, the arriving sound from the first speaker unit 2 and the arriving sound from the second speaker unit 3 are not destructive to each other, and consequently, the above-described effect is minimized.

Further, in the case of a higher frequency, for example 6 kHz, in the vicinity of 6 kHz at which a distance difference of 4 cm is equivalent to ¾ wavelength, a sound wave has a phase advance of 270° due to the foregoing distance difference, and hence, the phase of the arriving sound from the first speaker unit 5 to the listening position P advances by 180° as compared with the phase of the arriving sound from the second speaker unit 6 to the listening position P. In other words, considering the phase of the sound alone, in the vicinity of 6 kHz, the emitted sound of the first speaker unit 5 and the emitted sound of the second speaker unit 6 cancel each other; this is the inverse of the intended effect.

This applies to the speaker system 1 closer to the listening position P. More specifically, in the vicinity of 6 kHz at which a distance difference of 4 cm is equivalent to ¾ wavelength, a sound wave has a phase delay of 270° due to the foregoing distance difference, and hence, the phase of the arriving sound from the first speaker unit 2 to the listening position P delays by 360° as compared with the phase of the arriving sound from the second speaker unit 3 to the listening position P. In other words, considering the phase of the sound alone, in the vicinity of 6 kHz, the emitted sound of the first speaker unit 2 and the emitted sound of the second speaker unit 3 are constructive to each other; this is the inverse of the intended effect.

Therefore, desirably, the treble range of the second speaker units 3 and 6 are attenuated, as represented by the solid line A of FIG. 4. This is because the constructive and destructive effects from the superimposition of two sound waves are maximized when the two sound waves have similar sound pressures, and significantly decrease as a sound pressure difference between the two sound waves increases. Therefore, by attenuating the treble range of the second speaker units 3 and 6, the inverse effect can be prevented from occurring in the treble range in which a phase rotation of a sound wave due to a distance difference becomes excessive.

In the mid-range, with the above-described principle and operation, as shown in FIG. 6, a sound pressure vector V1 of the speaker system 1 closer to the listening position P can be decreased significantly as compared with a sound pressure vector V2 of the speaker system 4 farther from the listening position P. As a result, a sound image in the mid-range can be localized in the vicinity of the center position S of the display 7.

Based on the above-described principle and effect, a geometrical analysis was made regarding the appropriate conditions for causing a sound image to be localized in the vicinity of the center, in the case of the listening position P shown in FIG. 6, that is, in the case where the listening position P is positioned in the vicinity of the front direction of the speaker system 1 closer to the listening position P. As a result, though the description of a detailed calculation process is omitted herein, it was found that in the case of the standard arrangement in which the center listening position Pc and the respective speaker systems 1 and 4 are positioned in the vicinities of vertexes of an approximate regular triangle, sound image localization in the vicinity of the center can be obtained at the listening position P by setting the level difference between the sound pressure vector V1 of the speaker system 1 and the sound pressure vector V2 of the speaker system 2 to about 7.5 dB.

Besides, an analysis was made also regarding the case where the center listening position Pc and the respective speaker systems 1 and 4 are positioned in the vicinities of vertexes of a rectangular equilateral triangle, that is, the case where a front-back direction distance D from the speaker systems 1 and 4 to the listening positions Pc and P satisfies the position relationship of D=0.5 W. It was found that in this case, sound image localization in the vicinity of the center can be obtained at the listening position P as shown in FIG. 6 by setting the level difference between the sound pressure vector V1 of the speaker system 1 and the sound pressure vector V2 of the speaker system 2 to about 14 dB.

Thus, it was found that in order to obtain sound image localization in the vicinity of the center at the listening position P shown in FIG. 6, generally a sound pressure level difference of about 10 dB is required. In the above-described configuration, as shown in FIG. 5, there is a sound pressure difference of about 10 dB in the mid-range, and hence, an excellent effect of the center sound image localization can be achieved.

Next, an operation of the speaker device of the above-described configuration in the treble range is described with reference to FIG. 7. Since the sound pressure of the second speaker units 3 and 6 attenuates in the treble range as represented by the solid line A in FIG. 4, the effect in the treble range depends on the first speaker units 2 and 5.

In FIG. 7, the direction of sound emission from the first speaker unit 5 farther from the listening position P is in the vicinity of the front direction of the listening position P. On the other hand, the direction of sound emission of the first speaker unit 2 closer to the listening position P is tilted significantly with respect to the listening position P. Therefore, sounds from the first speaker unit 5 farther from the listening position P are not caused to have the treble-range attenuation due to the directivity characteristic of the first speaker unit 5. On the other hand, sounds from the first speaker unit 2 closer to the listening position P are caused to have the treble-range attenuation significantly due to the directivity characteristic of the first speaker unit 2.

As a result, the sound pressure vector V1 in the treble range of the first speaker unit 2 closer to the listening position P can be decreased significantly, as compared with the sound pressure vector V2 in the treble range of the first speaker unit 5 farther from the listening position P. Consequently, a sound image in the treble range can be localized in the vicinity of the center position S of the display 7.

According to acoustics, the following has been known: assuming that an effective vibrating radius and a wavelength constant of a speaker unit are a and k, respectively, there is no directivity at a frequency of about ka=1 or below, the directivity starts narrowing at a frequency of about ka=2 or above, and the directivity significantly narrows at a frequency of about ka=3 or above. In the speaker device of the above-described configuration, each of the first speaker units 2 and 5 has a diameter of about 6.5 cm, for example, and an effective vibrating radius thereof is about 26 mm. Therefore, the directivity starts narrowing in the vicinity of 4 kHz at which ka=2, and significantly narrows in the vicinity of 6 kHz or above at which ka=3.

Thus, according to the present embodiment, in a frequency band above 4 kHz at which the above-described effect based on the phase difference of emitted sounds and the position relationship of the first speaker units 2 and 5 and the second speaker units 3 and 6 becomes smaller, the effect based on the directivity of the first speaker units 2 and 5 is utilized. As a result, an effect of sufficiently decreasing the sound pressure vector V1 of the speaker system 1 closer to the listening position P as compared with the sound pressure vector V2 of the speaker system 4 farther from the listening position P can be obtained over the entire frequency band in the mid-range and above.

The above description discusses the operation and effect of the speaker device of the above-described configuration in the case where the listening position P is located in the vicinity of the front direction of the speaker system 1 closer to the listening position P. On the other hand, an analysis and experiments were carried out regarding the case where the listening position P was closer to the center listening position Pc, and the contrary case where the listening position P was moved further outward from the vicinity of the front of the speaker system 1.

As the listening position P approaches the center listening position Pc, an attenuated sound pressure level of the sound pressure vector V1 of the speaker system 1 closer to the listening position P should have a smaller difference from a sound pressure level of the sound pressure vector V2 of the speaker system 4 farther from the listening position P. For example, it was found as a result of calculation that when the listening position P is located at the midpoint between the position thereof shown in FIG. 6 and the center listening position Pc, the sound pressure level difference is about 4 dB in order to achieve a sufficient effect.

In other words, since the sound pressure level difference required when the listening position P is located in the vicinity of the front direction of the speaker system 1 closer to the listening position P is about 7.5 dB as described above, only about half the same is sufficient.

As the listening position P approaches the center listening position Pc, the difference between the distance to the listening position P from the first speaker units 2 and 5 and the distance thereto from the second speaker units 3 and 6 decreases roughly proportionally. Therefore, in the mid-range, the phase rotation amount of a sound wave owing to the distance difference decreases roughly proportionally, and the interference effect between arriving sounds owing to the phase rotation also decreases, whereas a sound pressure level difference required for localizing a sound image in the vicinity of the center also decreases roughly proportionally.

In the treble range also, as the listening position P approaches the center listening position Pc, since the tilt of the sound emission direction of the second speaker unit 2 closer to the listening position P decreases roughly proportionally, a sound pressure level difference caused by the tilt of the sound emission direction decreases, whereas a sound pressure level difference required for localizing a sound image in the vicinity of the center also decreases roughly proportionally.

Therefore, by employing a configuration in which an excellent effect of the center sound image localization can be obtained when the listening position P is located in the vicinity of the front direction of the speaker system 1 closer to the listening position P, in other words, by ensuring the required sound pressure level difference at the foregoing listening position, an excellent effect of the center sound image localization can be obtained, wherever the listening position P is located between the speaker systems 1 and 4. In other words, the listening position range where the center sound image localization can be achieved can be expanded to the full distance between the speaker systems 1 and 4.

It should be noted that, in fact, as long as the deviation of the sound image localization position from the center is not considerably significant, a practically sufficient effect of the center sound image localization can be achieved. For example, in a case such as movie appreciation where the listening and the viewing of a screen are performed at the same time, sound images tend to be localized approximately at the center easily. Therefore, even if the above-described sound pressure level difference when the listening position P is located in the vicinity of the front direction of the speaker system 1 closer to the listening position P is smaller than that in an ideal state, a practically sufficient effect can be achieved, though the listening position range in which the center sound image localization can be achieved is narrowed.

Next, the following describes results of analytical calculation regarding the case where the listening position P moves outward from the vicinity of the front of the speaker system 1. For example, when the listening position P moved to the left side by about W×½ from the position in the front direction of the speaker system 1 closer to the listening position P, the above-described required sound pressure level difference was found to be about 9.5 dB.

Besides, analytical calculation was made in the same manner regarding the case where the center listening position Pc and the respective speaker systems 1 and 4 are positioned in the vicinities of vertexes of a rectangular equilateral triangle, that is, the case where a depth direction distance D from the speaker system 1 and 4 to the listening positions Pc and P satisfies the position relationship of D=0.5 W. In this case, when the listening position P moved outward to the left side by about W×½ from the position in the front direction of the speaker system 1 closer to the listening position P, the above-described required sound pressure level difference was found to be about 14 dB.

In other words, it was found that when the listening position P moved outward from the vicinity of the front of the speaker system 1, the above-described required sound pressure level difference did not have much difference from the above-described required sound pressure level difference when the listening position P was located in the vicinity of the front direction of the speaker system 1.

Therefore, by setting the above-described sound pressure level difference to the required level when the listening position P is located in the vicinity of the front direction of the speaker system 1 or to a level slightly greater than that, the listening position range in which the center sound image localization is achieved can be expanded beyond the range extending between the speaker systems 1 and 4.

It should be noted that since the precedence effect works in actuality, better results can be obtained if the sound pressure level difference for obtaining the center sound image localization is set slightly greater than the above-described value. Conversely, if the above-described sound pressure level difference is excessively great, in some cases a sound image is localized at a position deviated, over the vicinity of the center, toward the speaker system farther from the listening position. In such a case, a small level difference may be provided between the sound pressure level of the first speaker unit 2 and 5 and the sound pressure level of the second speaker units 3 and 6 in the mid-range.

Next, as to the adjustment of frequency characteristics of a signal to be applied to the speaker unit in order to achieve the center sound image localization as described above, a frequency range for which such adjustment is needed is described below. The speaker device of the present embodiment is configured so that, as shown in FIG. 5, in the frequency band of about 1 kHz and above, the sound pressure vector V1 of the speaker system 1 closer to the listening position P is significantly smaller than the sound pressure vector V2 of the speaker system 4 farther from the listening position P. With this configuration, an improved effect can be achieved for expanding the listening position range in which the center sound image localization is achieved with respect to voices such as singing and speech in particular. A reason for this is described below.

Basic frequencies of human voices are about 80 Hz to 400 Hz for male voices, and about 150 Hz to 900 Hz for female and child voices, which are rather close to the bass range. It is known, however, that apart from these, there are peculiar frequency spectra called “formants”, which characterize human voices, and that the formants of vowels are important particularly.

The formants are called “first formant”, “second formant”, and “third formant” in the frequency ascending order. Irrespective of the language, for the male, female, and child voices in general, the range of the first formant frequency is about 300 Hz to 1 kHz. The range of the second formant frequency is about 800 Hz to 3 kHz, and the range of the third formant frequency is about 2.5 kHz to 4 kHz.

Experiments were carried out to find which frequency band, among the basic frequency of voice, the first formant frequency, the second formant frequency, and the third formant frequency, has the most significant influence on the effect of the center sound image localization. More specifically, a controlling operation of significantly attenuating a sound pressure arriving from the speaker system 1 closer to the listening position P as compared with a sound pressure arriving to the listening position P from the speaker system 4 farther from the listening position P was performed with respect to each of the foregoing frequency ranges, and the effect was checked.

As a result, only a very small effect was obtained in the case where the foregoing controlling operation was carried out with respect to the frequency band of 150 Hz to 900 Hz alone, which is the basic frequency of voice. A great effect was obtained by controlling the frequency range of the second formant, which was followed by an effect with respect to the third formant frequency, and an effect with respect to the first formant frequency. Also it was found that an extremely excellent effect was obtained by controlling both the second formant frequency and the third formant frequency. It can be considered that the fact that the frequency range of the second and third formants is the frequency band to which the human ears have high sensitivity is conducive to this.

It should be noted that even when the frequency range subjected to the foregoing controlling operation did not cover the overall range of the second formant frequency and the third formant frequency, in other words, even when a part of the frequency band of 800 Hz to 4 kHz was subjected to the foregoing operation, a practical effect was obtained also. Among the foregoing part of the frequency band, the frequency band in the vicinity of 2 kHz to 4 kHz was particularly effective. Also it was found that a sufficient effect was obtained by controlling the above-described mid-range, without specifically controlling the frequency band of 150 Hz to 900 Hz, which is the basic frequency of voice. Therefore, it was clarified that with regard to a low frequency band, there is no need to shift the phase of an emitted sound from each of the first speaker units 2 and 5 and the phase of an emitted sound from each of the second speaker units 3 and 6, even though a sense of discomfort is caused if sounds with opposite phases arrive to a human ear at the same time.

On the other hand, since voiced consonants contain much of high frequency components, by performing the foregoing controlling operation also in the treble range, an excellent effect of the center sound image localization can be achieved with respect to both vowels and consonants. Therefore, it was clarified that an excellent effect for expanding a listening position range in which the center sound image localization can be achieved with respect to a voice such as singing voice and speech in particular by performing the above-described controlling operation with respect to the mid-range and the treble range including a part or an entirety of the second formant frequency and the third formant frequency of the human voice.

### Preliminary Configuration for Embodiment

An acoustic reproduction device in an Embodiment of the present invention is configured so that each of the speaker systems included in the above-described speaker devices is configured so as to function as both a center speaker and a front speaker system for multichannel reproduction at the same time.

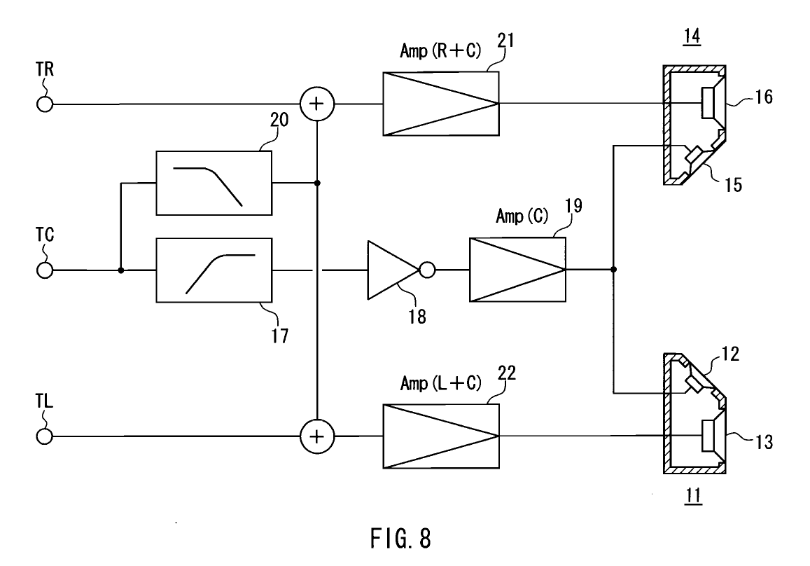

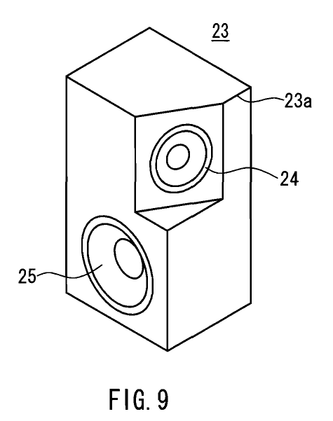

The acoustic reproduction device having such a configuration is described with reference to FIG. 8. The device shown in FIG. 8 has a configuration for allowing the same speaker systems 11 and 14 as the speaker systems 1 and 4 shown FIG. 1 to function as a center speaker and a front speaker system, when the speaker systems 11 and 14 are driven with signals having been subjected to the same signal processing as that of the network circuit shown in FIG. 3. This configuration corresponds to a preliminary stage for an Embodiment of the present invention.

In the configuration shown in FIG. 8, a left-side speaker system 11 is provided with a first speaker unit 12 and a second speaker unit 13. Aright-side speaker system 14 is provided with a first speaker unit 15 and a second speaker unit 16. The arrangement relationship of the first speaker units 12 and 15 and the second speaker units 13 and 16 is similar to that of the speaker device shown in FIG. 1.

In this acoustic reproduction device, however, each of the first speaker units 12 and 15 is, for example, a 6.5-cm-diameter full-range unit, and each of the second speaker units 13 and 16 is, for example, a 8-cm-diameter full-range unit.

As shown in a signal processing unit in FIG. 8, a center channel signal supplied to a terminal TC is divided into signals for two paths. A center channel signal supplied to one of the two paths is inputted to a 6-dB/oct-type HPF (high-pass filter) 17, so that a part thereof in the mid-range and the treble range is passed through, then a phase thereof is inverted by an inverter 18. Then, the signal is amplified by a center channel amplifier (C) 19, and drives the first speaker units 12 and 15. A center channel signal supplied to the other path is inputted to a 6-dB/oct-type LPF (low-pass filter) 20, so that a part thereof in the treble range is attenuated, then the signal is amplified by front channel amplifiers (R+C) 21 and (L+C) 22, so as to drive the second speaker units 13 and 16.

A front R channel signal and a front L channel signal fed via terminals TR and TL are fed to the amplifier (R+C) 21 and the amplifier (L+C) 22, respectively, and drive the second speaker units 13 and 16, respectively. In other words, each of the second speaker units 13 and 16 is fed with a superimposed signal of the center channel signal with the treble range attenuated and the front channel signal, and reproduces both signals together.

With this configuration, as to the center channel signal, the characteristics of input signals applied to the first speaker units 12 and 15 and the second speaker units 13 and 16 are similar to those of the speaker device described in the above “Basic Concept” section. Therefore, the operation and effect described above are exhibited with respect to the center channel signal, whereby an excellent effect of expanding the listening position range in which the center sound image localization can be achieved with respect to audio signals on the center channel can be achieved.

Thus, an acoustic reproduction device that reproduces the center channel and the front L and R channels can be obtained with a total of four speaker units, which is the minimum number of speaker units. With this configuration, since the center speaker system is configured integrally with the front speaker system, there is no need to install an independent center speaker system. In addition, it is possible to obtain a low-cost and small-size acoustic reproduction device for multichannel reproduction with which an excellent effect of the center sound image localization can be achieved with respect to audio signals on the center channel.

This configuration makes control easier when a sufficient distance in the horizontal direction can be ensured between the first speaker unit 12 (15) configured to be directed inward and the second speaker unit 13 (16) configured to be directed forward. However, otherwise, the following problem arises.

Specifically, as shown in FIG. 9, for example, a cabinet is configured to be long in the vertical direction in some cases, taking into consideration the convenience of placing the speaker device. In a speaker system 23 shown in FIG. 9, a first speaker unit 24 and a second speaker unit 25 are arranged so that the first speaker unit 24 emits sounds in an inward direction and the second speaker unit 25 emits sounds toward the vicinity in a front direction. Further, the first speaker unit 24 and the second speaker unit 25 are installed in a cabinet 23a so that they are arranged in a vertical relationship. This configuration makes it possible to downsize the speaker system 23 in the width direction.

However, in the case of such a speaker device, the first speaker unit 24 and the second speaker unit 25 are dose to each other in the horizontal direction. Therefore, it is difficult to make a distance therebetween in the horizontal direction sufficient, the distance being equivalent to the distance d1 in the horizontal direction between the first speaker unit 2 and the second speaker unit 3 shown in FIG. 1. As a result, it is difficult to adjust a sound pressure using a difference between a distance from the first speaker unit 24 to the listening position P and a distance from the second speaker unit 25 to the listening position P.

This results in such problems that: between the first speaker unit 24 directed inward and the second speaker unit 25 directed forward, phases in the mid-range sound are reverse to each other (have a difference of almost 180° therebetween), whereby a sound pressure significantly decreases in a certain frequency band and a smooth total frequency characteristic cannot be obtained; or a sound pressure vector directed to the center cannot be obtained sufficiently in a desired frequency band.

### Embodiment

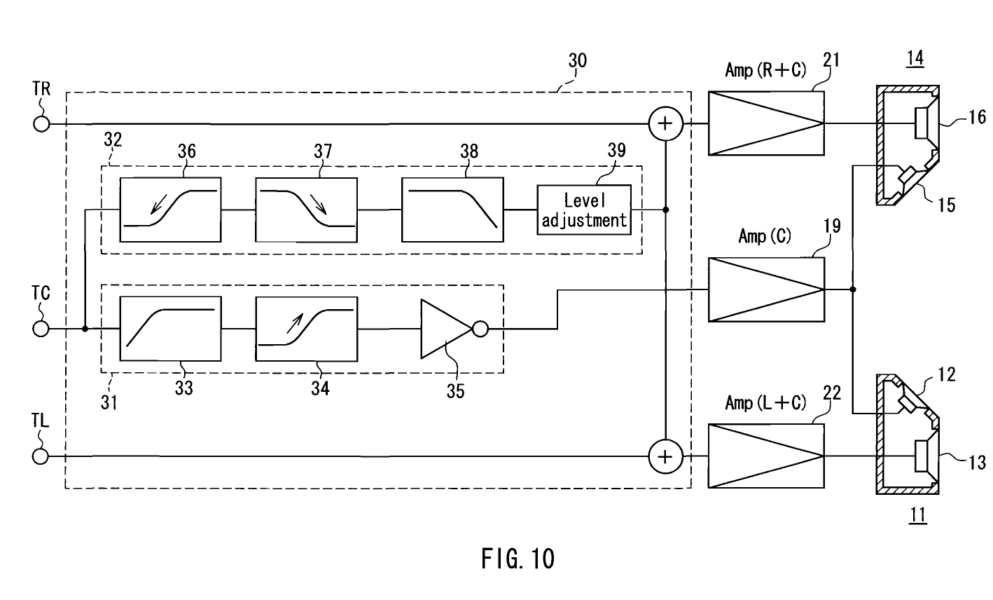

To solve these problems, in an Embodiment of the present invention, a signal processing unit 30 as shown in FIG. 10 is used in place of the signal processing unit in the acoustic reproduction device shown in FIG. 8. The signal processing unit 30 includes a first processing part 31 and a second processing part 32, and desirably is composed of a DSP (digital signal processor). The use of the DSP makes it possible to control a frequency characteristic of an input signal digitally with accuracy, and easily to obtain desired frequency characteristics as shown below.

The configuration of the acoustic reproduction device shown in FIG. 10 is particularly advantageous when it is applied to the speaker system 23 shown in FIG. 9, but for convenience of illustration, the same configuration using the speaker systems 11 and 12 as that shown in FIG. 8 is illustrated. In other words, in a left-side speaker system 11, a first speaker unit 12 and a second speaker unit 13 are installed. In a right-side speaker system 14, a first speaker unit 15 and a second speaker unit 16 are installed. The arrangement relationship of the first speaker units 12 and 15 and the second speaker units 13 and 16 may be similar to that of the speaker device shown in FIG. 9.

In the signal processing unit 30, a center channel signal supplied to a terminal TC is divided into signals for two paths. A center channel signal supplied to one of the two paths is processed by the first processing part 31 and is amplified by an amplifier (C) 19, so as to drive the first speaker units 12 and 15. The first processing part 31 is composed of a HPF block 33, a first high-shelf block 34, and a phase inversion block 35. A center channel signal supplied to the other path is processed by the second processing part 32 and is amplified by an amplifier (R+C) 18 and an amplifier (L+C) 19, so as to drive the second speaker units 13 and 16. The second processing part 32 is composed of a low-shelf block 36, a second high-shelf block 37, a LPF block 38, and a level adjustment block 39.

A front R channel signal and a front L channel signal fed via terminals TR and TL are amplified by the amplifier (R+C) 21 and the amplifier (L+C) 22, respectively, and drive the second speaker units 13 and 16, respectively. In other words, to the second speaker units 13 and 16, the center channel signal having been processed by the second processing part 32 and front channel signals are fed in a superimposed state, and are reproduced together.

The HPF block 33 cuts off low frequencies. The first high-shelf block 34 performs a processing operation for obtaining a step-like characteristics such that a level of a signal in a high range higher than a cut-off frequency is boosted. The low-shelf block 36 performs a processing operation for obtaining a step-like characteristics such that a level of a signal in a middle and low range lower than a cut-off frequency is dropped. The second high-shelf block 37 performs a processing operation for obtaining a step-like characteristics such that a level of a signal in a high range higher than a cut-off frequency is dropped. The LPF block 38 cuts off high frequencies.

Exemplary coefficients set for the blocks are shown in Table 1 below, which are set in the case of an acoustic reproduction device configured so that 6.5-cm-diameter cone-type speaker units are used for the first speaker units 12 and 15 and the second speaker units 13 and 16, and a distance in the horizontal direction between the first speaker unit 12 (15) and the second speaker unit 13 (16) is set at 20 mm. The order of each filter or the like is the second order.

TABLE 1

| | | Resonance | |
|---|---|---|---|
| | Cut-off | sharpness | Step level |
| Block | frequency | (Q) | difference |
| HPF block 33 | 450 Hz | 0.7 | — |
| First high-shelf block 34 | 3000 Hz | 0.7 | 3 dB |
| Low-shelf block 36 | 430 Hz | 0.7 | −2 dB |
| Second high-shelf block 37 | 3600 Hz | 0.7 | −3 dB |
| LPF block 38 | 8000 Hz | 0.7 | — |
| Level adjustment block 39 | — | — | 0 dB |

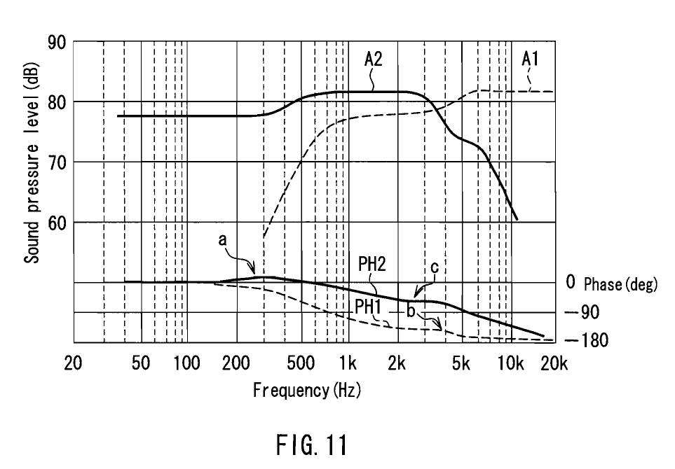

In this exemplary setting, no signal level adjustment is carried out, but in some cases it is needed depending on a speaker unit used. FIG. 11 shows frequency characteristics of a signal supplied to the amplifier (C) 19 (a signal for the first speaker units 12, 15) and frequency characteristics of a mixed signal supplied to the amplifiers (R+C) 18 and (L+C) 19 (a signal for the second speaker units 13, 16) obtained in this configuration. A level frequency characteristic of the signal for the first speaker units 12 and 15 is indicated by a broken line A1, and a phase frequency characteristic thereof is indicated by a broken line PH1. A level frequency characteristic of the signal for the second speaker units 13 and 16 is indicated by a solid line A2, and a phase frequency characteristic thereof is indicated by a solid line PH2.

The low-shelf block 36 has a function of adjusting a level and a phase of a middle- and low-range component of a signal allocated to the second speaker units 13 and 16, and in the relationship with the signal supplied to the first speaker units 12 and 15, the low-shelf block 36 makes a significant contribution to the flattening of the total frequency characteristic for frequencies of 2 kHz or lower. It should be noted that when the level of the signal for the second speaker units 13 and 16 is adjusted by the low-shelf block 36, the phase characteristic also varies as indicated by a reference numeral “a”. Therefore, the relationship with the level and phase of the signal applied to the first speaker units 12 and 15 may be adjusted minutely by the setting of the cut-off frequency and the value Q, whereby a flat total frequency characteristic can be obtained.

The first high-shelf block 34 has a function of correcting energy in the high range of a signal for the first speaker units 12 and 15 (high range boosting). However, as indicated by a reference numeral “b” in FIG. 11, the phase characteristic also varies. Therefore, the second high-shelf block 37 appropriately controls the phase of the signal applied to the second speaker units 13 and 16, as indicated by a reference numeral “c”, in a frequency band in which the phase characteristic of the signal applied to the first speaker units 12 and 15 varies. This allows the minute adjustment for obtaining the flat total frequency characteristic for frequencies of 2 kHz or lower as described above to be carried out.

With the above-described configuration, even if it is difficult to ensure a sufficient distance in the horizontal direction between the first speaker units 12 and the second speaker unit 13, an excellent effect of the central sound image localization can be achieved with respect to a center channel audio signal.

It should be noted that in the present embodiment, when an angle β (see FIG. 1) between a sound emission direction of the first speaker unit 12 and 15 and the listening center axis X1-X2 is set in a range of 15° to 90° also, the effect as described above can be achieved.

An increase in this angle β allows the dimensions in the width direction of the speaker systems 11 and 14 to decrease. However, in this case, sounds in the treble range tend to be insufficient owing to the directivity of the first speaker units 12 and 15. Therefore, the boosting of sounds in the treble range with use of an amplifier or the like may be recommended.

A decrease in this angle β allows the dimensions in the front-back direction of the speaker systems 11 and 14 to decrease. However, in this case, the listening position at which the effect of the present invention can be achieved is located at a position in the front-back direction far from the speaker systems 11 and 14. Therefore, the angle β may be determined with the dimensions required of the speaker systems and the desired listening position range being taken into consideration.

The sound emission direction of the second speaker units 13 and 16 may be any direction as long as it is outward as compared with the sound emission direction of the first speaker units 12 and 15, and are not necessarily a completely front direction. Further, if an angle α (see FIG. 1) between the sound emission directions of the second speaker units 13 and 16 and the sound emission directions of the first speaker units 12 and 15, respectively, is set at 15° to 90°, it is possible to achieve an effect as described above.

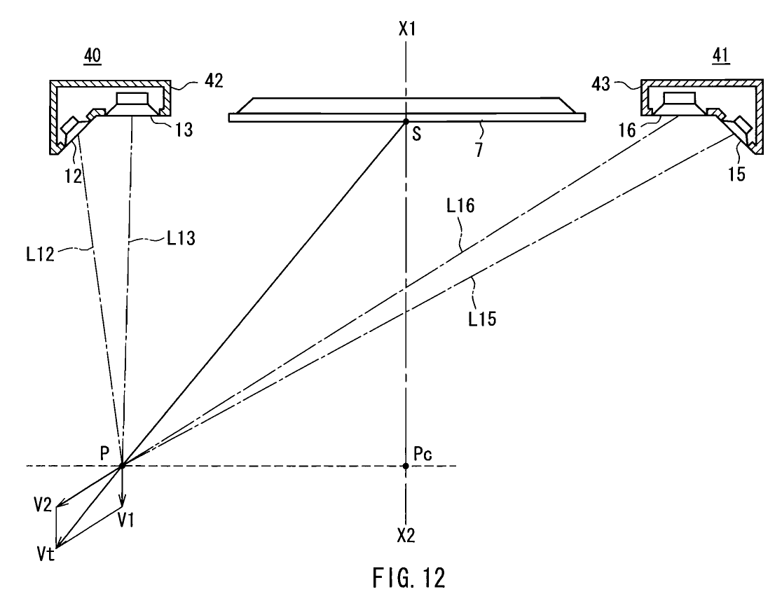

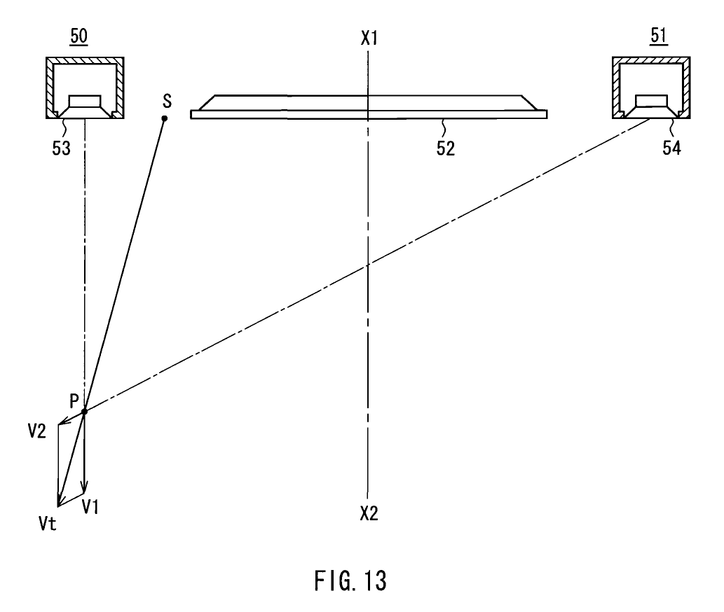

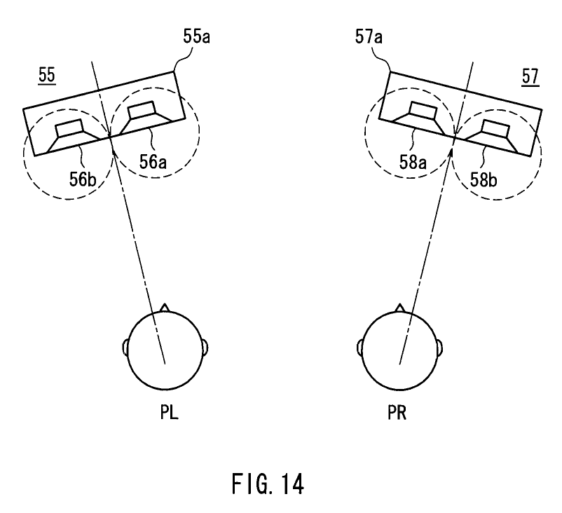

In the acoustic reproduction device according to the Embodiment of the present invention, the speaker units may be arranged as shown in FIG. 12. In FIG. 12, first speaker units 12 and 15 and second speaker units 13 and 16 are the same as those shown in FIG. 10, and a display 17 is the same as that shown in FIG. 6. This arrangement is different from the case shown in FIG. 10 in the shape of the left-side speaker system 40 and the shape of the right-side speaker system 41, i.e., the shapes of cabinets 42 and 43, and the arrangement relationship of the speaker units 12, 13, 15, and 16.

The first speaker units 12 and 15 are arranged on outer sides with respect to the second speaker units 13 and 16, respectively, and are arranged so as to emit sounds in inward directions. The second speaker units 13 and 16 are arranged so as to emit sounds in the front direction, and to emit sounds in outward directions as compared with the first speaker units 12 and 15, respectively. Each angle of the sound emission directions of the first speaker units 12 and 15 with respect to the listening center axis X1-X2 is approximately 45°.

In the case of this arrangement, in which the first speaker units 12 and 15 are arranged on outer sides with respect to the second speaker units 13 and 16, respectively, a distance L15 to the listening position P from the first speaker unit 15 of the right-side speaker system 14 farther from the listening position P becomes about 4 cm longer than a distance L16 from the second speaker unit 16 to the listening position P, as shown in FIG. 12.

On the other hand, a distance L12 to the listening position P from the first speaker unit 12 of the left-side speaker system 40 closer to the listening position P is about 4 cm shorter than a distance L13 to the listening position P from the second speaker unit 13.

Contrary to the case of the arrangement as shown in FIGS. 6, 10, etc., therefore, the phase of an emitted sound of the first speaker units 12 and 15 is caused to advance by about 90° in a range from the mid-range to the treble range as compared with the phase of an emitted sound of the second speaker units 13 and 16.

Since the phase of an emitted sound of the first speaker unit 15 has already advanced by about 90° in the mid-range as compared with the phase of an emitted sound of the second speaker unit 16, the phase difference therebetween at the listening position P decreases. This causes a phase difference between a sound having arrived from the first speaker unit 15 and a sound having arrived from the second speaker unit 16 to approach 0°, whereby both the emitted sounds are constructive to each other. Thus, the same operation and effect as those in the above-described case can be achieved.

Further, since the phase of an emitted sound of the first speaker unit 12 has already advanced by about 90° in the mid-range as compared with the phase of an emitted sound of the second speaker unit 13, the phase difference therebetween at the listening position P increases. This causes the phase difference between a sound arriving from the first speaker unit 15 and a sound arriving from the second speaker unit 16 to approach 180°, whereby both the emitted sounds are destructive to each other.

Thus, in the case of the configuration shown in FIG. 12 also, the same operation and effect as those described with reference to FIG. 6 can be achieved. Besides, in this configuration, since the first speaker units 12 and 15 are arranged on outer sides with respect to the second speaker units 13 and 16, respectively, the emitted sounds of the first speaker units 12 and 15 become less obstructed by the display. Therefore, the left-side speaker system 40 and the right-side speaker system can be disposed further back.

### INDUSTRIAL APPLICABILITY

The acoustic reproduction device of the present invention has an excellent effect of expanding the listening position range in which the center sound image localization can be achieved with respect to a voice such as singing voice or speech also, and is configured so that a center speaker for multichannel reproduction can be provided integrally with left-side and right-side front speaker systems. Therefore, the acoustic reproduction device of the present invention is useful, not only for sound reproduction of general two-channel stereophonic reproduction equipment or multichannel sound reproduction equipment, but also for sound reproduction of electronic equipment in general, such as sound reproduction equipment for television, on-vehicle sound reproduction equipment, sound reproduction equipment built in personal computers, and portable sound reproduction equipment.

1. An acoustic reproduction device comprising:
a pair of speaker systems, each speaker system having a first speaker unit and a second speaker unit;
a signal processing unit that performs a predetermined processing operation with respect to an input signal; and
an amplifier that amplifies an output signal from the signal processing unit, and applies the signal to the speaker systems,
wherein when the pair of speaker systems are arranged symmetrically with respect to a listening center axis, the first speaker units are arranged symmetrically with respect to the listening center axis, and the second speaker units are arranged symmetrically with respect to the listening center axis,
wherein the first and second speaker units are arranged so that the first speaker unit emits a sound in an inward direction, and the second speaker unit emits a sound in a front direction of the speaker system or in an outward direction as compared with the direction of the first speaker unit, where the inward direction is defined as a direction toward the listening center axis from each speaker system,
the signal processing unit comprises;
a first processing part that processes a center channel signal, of multichannel signals supplied as input signals, and outputs the processed signal as a signal for the first speaker unit; and a second processing part that processes the center channel signal and outputs the processed signal as a signal for the second speaker unit, thereby superimposing respective front channel signals, of the multichannel signals, onto the output signal of the second processing part, and supplying the superimposed signals to the second speaker units, respectively,
the first processing part comprising a high-pass filter block that performs a processing operation for attenuating a low-range component of the center channel signal; and a first high-shelf block that performs a processing operation for obtaining a step-like characteristics for boosting a high-range component,
the second processing part comprising a low-pass filter block that performs a processing operation for attenuating a high-range component of the center channel signal; a low-shelf block that performs a processing operation for obtaining a step-like characteristics for attenuating a part of a low-range signal component, of signal components in a band below the high-range component attenuated by the low-pass filter block; and a second high-shelf block that performs a processing operation for obtaining a step-like characteristics for attenuating a part of a high-range signal component, and
at a listening position in a front direction of one of the speaker systems, a reproduced sound of the center channel signal arriving from the first speaker unit of the one of the speaker systems that is closer to the listening position, and a reproduced sound of the center channel signal arriving from the second speaker unit of the same speaker system, are destructive to each other in the mid-range owing to a phase difference therebetween.

2. The acoustic reproduction device according to claim 1, wherein the mid-range is set to a frequency range including 1.5 kHz.

3. The acoustic reproduction device according to claim 2, wherein the mid-range is set to a frequency range including a part or an entirety of the second formant frequency and the third formant frequency of human voice.

4. The acoustic reproduction device according to claim 1,
wherein the first speaker unit is arranged on an inner side with respect to the second speaker unit as viewed from the listening center axis, and
in the mid-range, a phase of an emitted sound of the first speaker unit is delayed as compared with a phase of an emitted sound of the second speaker unit.

5. The acoustic reproduction device according to claim 1,
wherein the first speaker unit is arranged on an outer side with respect to the second speaker unit as viewed from the listening center axis, and
in the mid-range, a phase of an emitted sound of the first speaker unit is advanced as compared with a phase of an emitted sound of the second speaker unit.

6. The acoustic reproduction device according to claim 1, wherein the first speaker unit and the second speaker unit are arranged in a vertical relationship.
